(19) United States
(12) Patent Application Publication
(10) Pub. No.: US 2013/0300201 A1
(43) Pub. Date: Nov. 14, 2013

(54) POWER CENTER

(71) Applicant: Jui-Hsiung Wu, Taipei (TW)

(72) Inventor: Jui-Hsiung Wu, Taipei (TW)

(21) Appl. No.: 13/470,368

(22) Filed: May 14, 2012

(51) Int. Cl. H02J 3/04

(52) U.S. Cl. 307/82

(57) ABSTRACT

A power center includes a main body of which a top surface defines a plurality of receiving cavities. A plurality of different standards of adapter sockets is equipped in the main body and each is exposed to one receiving cavity. A power plug connects with the main body through a wire. A plurality of converter modules each includes a plug part and a socket part. The plug parts have different standards for corresponding to the adapter sockets and different countries of wall sockets. The socket parts each is designed in accordance with the standard of the power plug. The converter modules are removably disposed in the receiving cavities respectively by plugging the plug parts in the corresponding adapter sockets, and each can be taken out from the receiving cavity to plug the power plug into the socket part thereof so as to use the power center in different countries.

### BACKGROUND OF THE INVENTION

1. Field of the Invention

The present invention relates to a power center, and more particularly to a power center capable of being used in different countries.

2. The Related Art

With the development of technology, all kinds of different types of power centers came with the tide of fashion. The power center usually includes a main body, a power plug and a wire connecting with the main body and the power plug. A surface of the main body is provided with a plurality of stationary sockets arranged apart from one another. The power plug of the power center only applies to a kind of wall socket. However, the wall sockets of different countries often have different standards. As a result, when users go abroad, many different types of extra converters need be taken for meeting different standards of the wall sockets. It brings inconvenience for the users.

### SUMMARY OF THE INVENTION

Accordingly, an object of the present invention is to provide a power center adapted for being used in different countries. The power center includes a main body of which a top surface defines a plurality of receiving cavities. A plurality of different standards of adapter sockets is equipped in the main body and each is exposed to one of the receiving cavities. A power plug connects with the main body through a wire. A plurality of converter modules each includes a plug part and a socket part. The plug parts of the converter modules have different standards for corresponding to the adapter sockets in the main body and further corresponding to different countries of wall sockets. The socket parts each is designed in accordance with the standard of the power plug. The converter modules are removably disposed in the receiving cavities of the main body respectively by means of plugging the plug parts in the corresponding adapter sockets.

As described above, the top surface of the main body defines a plurality of receiving cavities where a plurality of different standards of adapter sockets is equipped. The converter modules are removably disposed in the receiving cavities of the main body respectively by means of plugging the plug parts in the corresponding adapter sockets. When used, the converter module is capable of being taken out from the receiving cavity to plug the power plug into the socket part thereof so as to use the power center in different countries.

### BRIEF DESCRIPTION OF THE DRAWINGS

The present invention will be apparent to those skilled in the art by reading the following description thereof, with reference to the attached drawings, in which:

FIG. 1 is an assembled perspective view of a power center in accordance with one embodiment of the present invention;

FIG. 2 is a perspective view of the power center of FIG. 1 excluding a plurality of converter modules;

FIG. 3 is a perspective view of the converter modules;

FIG. 4 is a perspective view of a power center in accordance with another embodiment of the present invention, wherein the converter modules of FIG. 3 are departed from the power center; and

FIG. 5 is a use perspective view of the power center shown in FIG. 1.

### DETAILED DESCRIPTION OF THE EMBODIMENT

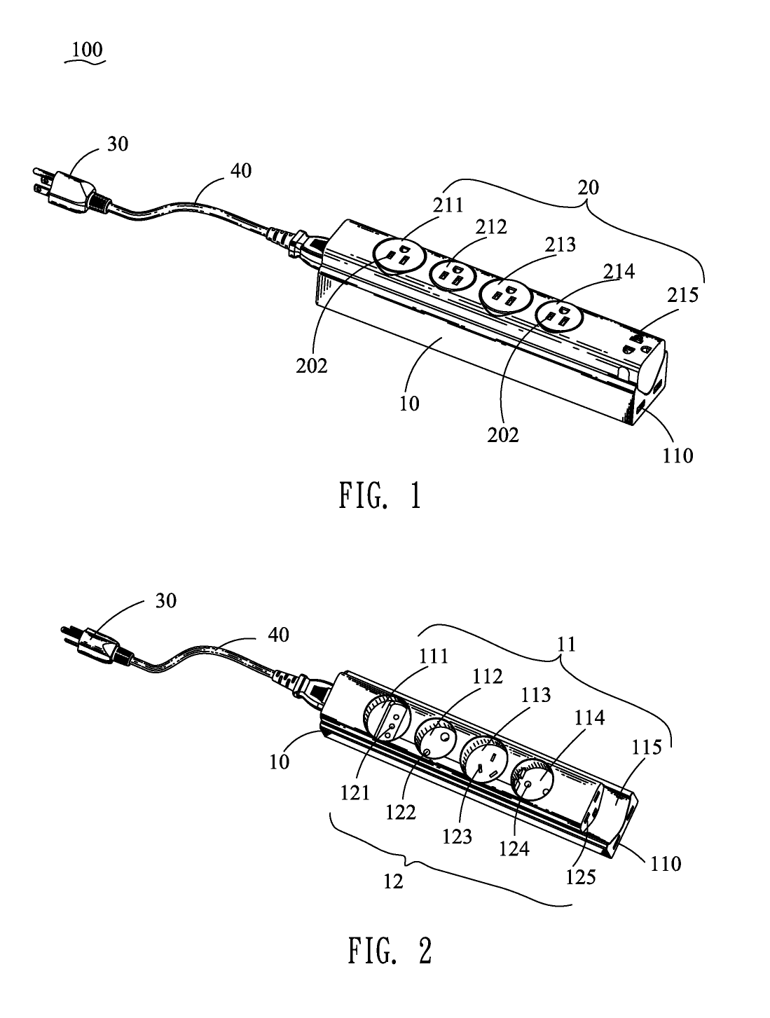

Referring to FIG. 1 and FIG. 4, a power center 100 capable of being used in different countries includes a main body 10, a plurality of converter modules 20 removably assembled in the main body 10, a power plug 30 and a wire 40 connecting with the power plug 30 and the main body 10.

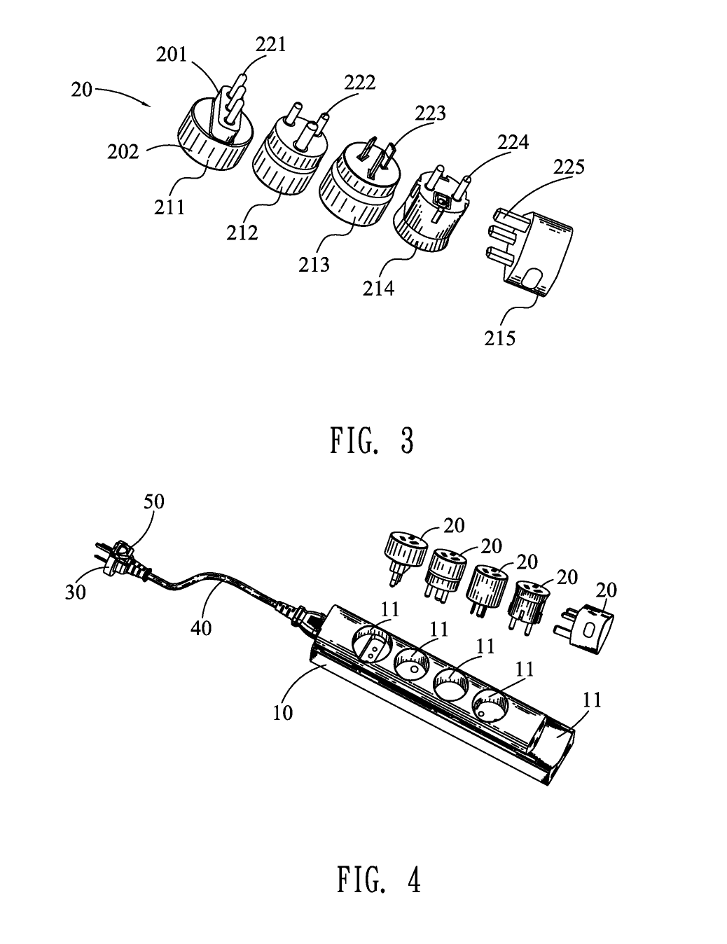

Referring to FIGS. 1-4, the main body 10 is substantially of a rectangular shape, and a top surface thereof defines a plurality of receiving cavities 11. A plurality of different standards of adapter sockets 12 is equipped in the main body 10 and each is exposed to one of the receiving cavities 11. The main body 10 defines more at least four receiving cavities 11. One of the receiving cavities 11 is opened in a rear end of the main body 10 opposite to the power plug 30 and penetrates rearward through the main body 10, with a front sidewall thereof being equipped with the corresponding adapter socket 12 for inserting the corresponding converter module 20 forward in the receiving cavity 11. Other receiving cavities 11 each is vertically opened in the main body 10 with the corresponding adapter socket 12 being equipped in a bottom wall thereof. The receiving cavities 11 of the main body 10 are substantially of cylindrical shape and the converter modules 20 are in accordance with the receiving cavities 11 in size and shape. In this embodiment, the receiving cavities 11 include a first receiving cavity 111, a second receiving cavity 112, a third receiving cavity 113, a fourth receiving cavity 114 and a fifth receiving cavity 115. The fifth receiving cavity 115 is opened in the rear end of the main body 10, and the front sidewall thereof is equipped with a Japan and American adapter socket 125. The first receiving cavity 111, the second receiving cavity 112, the third receiving cavity 113 and the fourth receiving cavity 114 are vertically opened in the main body 10 with an Italy adapter socket 121, a South African adapter socket 122, a France and Germany adapter socket 123 and a United Kingdom adapter socket 124 being equipped in the bottom walls thereof respectively. A rear face of the main body 10 opposite to the power plug 30 defines a plurality of USB ports 110 located under the fifth receiving cavity 115.

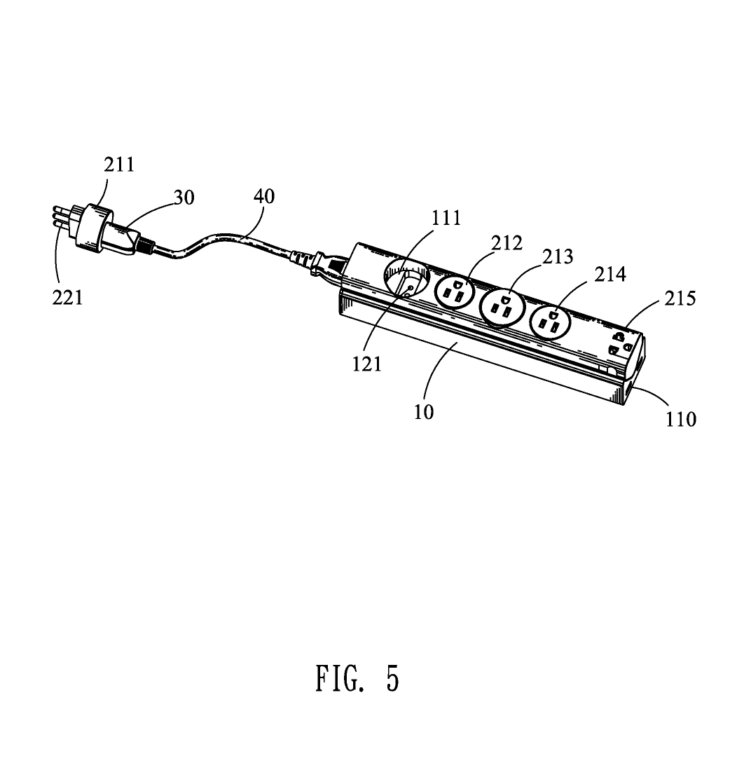

Referring to FIGS. 1-5, the converter modules 20 each includes a plug part 201 and a socket part 202. The plug parts 201 of the converter modules 20 have different standards for corresponding to the adapter sockets 12 in the main body 10 and further corresponding to different countries of wall sockets (not shown). The socket parts 202 each is designed in accordance with the standard of the power plug 30. The converter modules 20 are removably disposed in the receiving cavities 11 of the main body 10 respectively by means of plugging the plug parts 201 in the corresponding adapter sockets 12. In this embodiment, the converter modules 20 include a first converter 211, a second converter 212, a third converter 213, a fourth converter 214 and a fifth converter 215. The plug parts 201 of the first converter 211, the second converter 212, the third converter 213, the fourth converter 214 and the fifth converter 215 are an Italy plug 221, a south African plug 222, a France and Germany plug 223, a United kingdom plug 224, a Japan and American plug 225 in accordance with the Italy adapter socket 121, the South African adapter socket 122, the France and Germany adapter socket 123, the United Kingdom adapter socket 124, the Japan and American adapter socket 125, respectively. The first converter 211, the second converter 212, the third converter 213, the fourth converter 214 and the fifth converter 215 are removably disposed in the first receiving cavity 111, the second receiving cavity 112, the third receiving cavity 113, the fourth receiving cavity 114 and the fifth receiving cavity 115 of the main body 10 respectively by means of plugging the Italy plug 221, the south African plug 222, the France and Germany plug 223, the United kingdom plug 224 and the Japan and American plug 225 in the corresponding Italy adapter socket 121, the South African adapter socket 122, the France and Germany adapter socket 123, the United Kingdom adapter socket 124, the Japan and American adapter socket 125 respectively. When used, the converter module 20 is capable of being taken out from the receiving cavity 11 of the main body 10 to plug the power plug 30 into the socket part 202 thereof so as to use the power center 100 in different countries.

Referring to FIG. 1 and FIG. 4, the socket parts 202 of the converter modules 20 and the power plug 30 are designed according to a common standard in daily life. For example, the users are usually live in China, and accordingly, the power plug 30 and the socket parts 202 of the converter modules 20 are designed to China and Canada plug and sockets. Furthermore, a driving device 50 is movably assembled to the power plug 30 in FIG. 4 for the convenience of pushing out the converter modules 20 from the power plug 30.

As described above, the top surface of the main body 10 defines a plurality of receiving cavities 11 where a plurality of different standards of adapter sockets 12 is equipped. The converter modules 20 are removably disposed in the receiving cavities 11 of the main body 10 respectively by means of plugging the plug parts 201 thereof in the corresponding adapter sockets 12. When used, the converter module 20 is capable of being taken out from the receiving cavity 11 to plug the power plug 30 into the socket part 202 thereof so as to use the power center 100 in different countries.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A power center adapted for being used in different countries, comprising:
a main body of which a top surface defines a plurality of receiving cavities, a plurality of different standards of adapter sockets being equipped in the main body and each being exposed to one of the receiving cavities;
a power plug connecting with the main body through a wire; and
a plurality of converter modules each including a plug part and a socket part, the plug parts of the converter modules having different standards for corresponding to the adapter sockets in the main body and further corresponding to different countries of wall sockets, the socket parts each being designed in accordance with the standard of the power plug, the converter modules being removably disposed in the receiving cavities of the main body respectively by means of plugging the plug parts in the corresponding adapter sockets, when used, the converter module being capable of being taken out from the receiving cavity to plug the power plug into the socket part thereof so as to use the power center in different countries.

2. The power center as claimed in claim 1, wherein the main body defines more at least four receiving cavities.

3. The power center as claimed in claim 1, wherein the main body is substantially of a rectangular shape, one of the receiving cavities is opened in a rear end of the main body opposite to the power plug and penetrates rearward through the main body, a front sidewall of the receiving cavity is equipped with the corresponding adapter socket for inserting the corresponding converter module forward in the receiving cavity.

4. The power center as claimed in claim 3, wherein other receiving cavities each is vertically opened in the main body with the corresponding adapter socket being equipped in a bottom wall thereof

5. The power center as claimed in claim 1, wherein a rear face of the main body opposite to the power plug defines a plurality of USB ports.

6. The power center as claimed in claim 1, wherein a driving device is movably assembled to the power plug for pushing out the converter modules from the power plug.

7. The power center as claimed in claim 1, wherein the receiving cavities of the main body are substantially of cylindrical shape and the converter modules are in accordance with the receiving cavities in size and shape.
